(19) United States
(12) Patent Application Publication
(10) Pub. No.: US 2019/0020929 A1
(43) Pub. Date: Jan. 17, 2019

(54) APPARATUS AND METHODS FOR PROVIDING TELEVISION CONTENT TO A USER

(71) Applicant: Mastercard International Incorporated, Purchase, NY (US)

(72) Inventors: Nishant Maheshwari, Aligarh (IN); Ashutosh Kumar Gupta, Varanasi (IN); Ajay Nehra, Gurgaon (IN)

(73) Assignee: Mastercard International Incorporated, Purchase, NY (US)

(21) Appl. No.: 16/033,505

(22) Filed: Jul. 12, 2018

(30) Foreign Application Priority Data
Jul. 12, 2017 (SG) 10201705741X

(51) Int. Cl. H04N 21/81; H04N 21/44; H04N 21/438; H04N 21/442

(52) U.S. Cl. CPC H04N 21/812; H04N 21/44222; H04N 21/4383; H04N 21/44016

(57) ABSTRACT

An apparatus for providing television content to a user is disclosed. The apparatus comprises: a computer processor and a data storage device, the data storage device having a television channel selection module; an advertisement portion identification module; a television channel monitoring module; and a relevant advertisement identification module comprising non-transitory instructions operative by the processor to: receive a plurality of television channel signals, each television channel signal comprising program content portions and advertising content portions, the advertising portions each comprising at least one advertising content item; provide a program content portion of a user selected first television channel signal from the plurality of television channel signals as a display signal to be displayed to the user; identify an advertising content portion in the first television channel signal; monitor a plurality of other television channel signals of the plurality of television channel signals during the advertising portion of the first television channel signal; identify a user relevant advertising content item in a second television channel signal of the plurality of other television channel signals during the advertising portion of the first television channel signal; and switch the display signal to the second television channel signal.

### CROSS REFERENCE TO RELATED APPLICATIONS

This application claims priority to Singapore Application Serial No. 10201705741X, filed Jul. 12, 2017, which is incorporated herein by reference in its entirety.

### TECHNICAL FIELD AND BACKGROUND

The present disclosure relates to the provision of television content to a user. In particular, the present disclosure relates to the provision of advertising content to television viewers, for example, in cable or satellite television transmission systems.

Advertisements in the digital space, for example, the internet are often targeted to specific users. For example, advertisements displayed to an internet user may be based on the person's browsing history. It is therefore possible to predict a probable product/service that the customer may be looking for and hence customized targeting of advertisements can be provided.

Advertisements are often presented in broadcast television. However, in broadcast television, targeted advertisements not often provided. There are two reasons for this. Firstly, there is no information about the customer or viewer to determine which advertisements would be relevant for the customer. Secondly, the television experience is not customized like the Internet and all the people see same telecast on a particular channel. Therefore it is challenging to provide advertisements on television that are customized to every viewer. Therefore many advertisements shown in television may not be relevant to all viewers.

### SUMMARY

In general terms, the present disclosure proposes methods and systems for providing television advertising content to users by switching between television channel signals when an advertising content portion is identified in a channel being viewed by the user. A plurality of channels are monitored and when an advertising content item is identified as relevant to the user on one of the channel signals, a display signal provided for viewing by the user is switched to that advertising content item.

According to a first aspect of the present invention, an apparatus for providing television content to a user. The apparatus comprises: a computer processor and a data storage device, the data storage device having a television channel selection module; an advertisement portion identification module; a television channel monitoring module; and a relevant advertisement identification module comprising non-transitory instructions operative by the processor to: receive a plurality of television channel signals, each television channel signal comprising program content portions and advertising content portions, the advertising portions each comprising at least one advertising content item; provide a program content portion of a user selected first television channel signal from the plurality of television channel signals as a display signal to be displayed to the user; identify an advertising content portion in the first television channel signal; monitor a plurality of other television channel signals of the plurality of television channel signals during the advertising portion of the first television channel signal; identify a user relevant advertising content item in a second television channel signal of the plurality of other television channel signals during the advertising portion of the first television channel signal; and switch the display signal to the second television channel signal.

In an embodiment, the relevant advertisement identification module further comprising non-transitory instructions operative by the processor to: identify a user relevant advertising content item by comparing a content category indication associated with advertising content items in each of the plurality of television channel signals with stored user profile data indicating content categories relevant to the user.

In an embodiment, the data storage device further comprising a user profile management module comprising non-transitory instructions operative by the processor to: receive user browsing data indicating browsing history of the user; determine content categories relevant to the user from the user browsing data; and store indications of the content categories relevant to the user as user profile data.

In an embodiment, the television channel selection module further comprises non-transitory instructions operative by the processor to switch the display channel back to the first television channel signal after an advertising portion duration time has passed.

In an embodiment, the television channel selection module further comprises non-transitory instructions operative by the processor to switch the display channel back to the first television channel signal when a program content portion is identified on the first television channel signal.

In an embodiment, the data storage device further comprising a history data management module comprising non-transitory instructions operative by the processor to: store indications of advertising content items included in the display signal as advertisement history display data.

In an embodiment, the history data management module further comprises non-transitory instructions operative by the processor to: send the advertisement history display data to an advertising processing server.

In an embodiment, the advertisement portion identification module further comprises non-transitory instructions operative by the processor to: identify an advertising portion in the first television channel signal from a content type indicator in the first television channel signal.

In an embodiment the apparatus forms a set-top box.

According to a second aspect of the present invention a method of providing television content to a user is provided. The method comprises: receiving a plurality of television channel signals, each television channel signal comprising program content portions and advertising content portions, the advertising portions each comprising at least one advertising content item; providing a program content portion of a user selected first television channel signal from the plurality of television channel signals as a display signal to be displayed to the user; identifying an advertising content portion in the first television channel signal; monitoring a plurality of other television channel signals of the plurality of television channel signals during the advertising portion of the first television channel signal; identifying a user relevant advertising content item in a second television channel signal of the plurality of other television channel signals during the advertising portion of the first television channel signal; and switching the display signal to the second television channel signal.

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

Embodiments of the invention will now be described for the sake of non-limiting example only, with reference to the following drawings in which:

FIG. 1 is a block diagram showing a system for providing television content to a user according to an embodiment of the present invention;

FIG. 2 is a block diagram illustrating a technical architecture of a channel selection and switching component of a set-top box according to an embodiment of the present invention;

FIG. 3 shows the structure of television channel signals processed in embodiments of the present invention;

FIG. 4 is a flowchart showing a method of providing television content for display to a user according to an embodiment of the present invention;

FIG. 5 is a flowchart showing a method of updating user profile data in an embodiment of the present invention; and

FIG. 6 is a flowchart showing a method of storing advertisement history data in an embodiment of the present invention.

### DETAILED DESCRIPTION

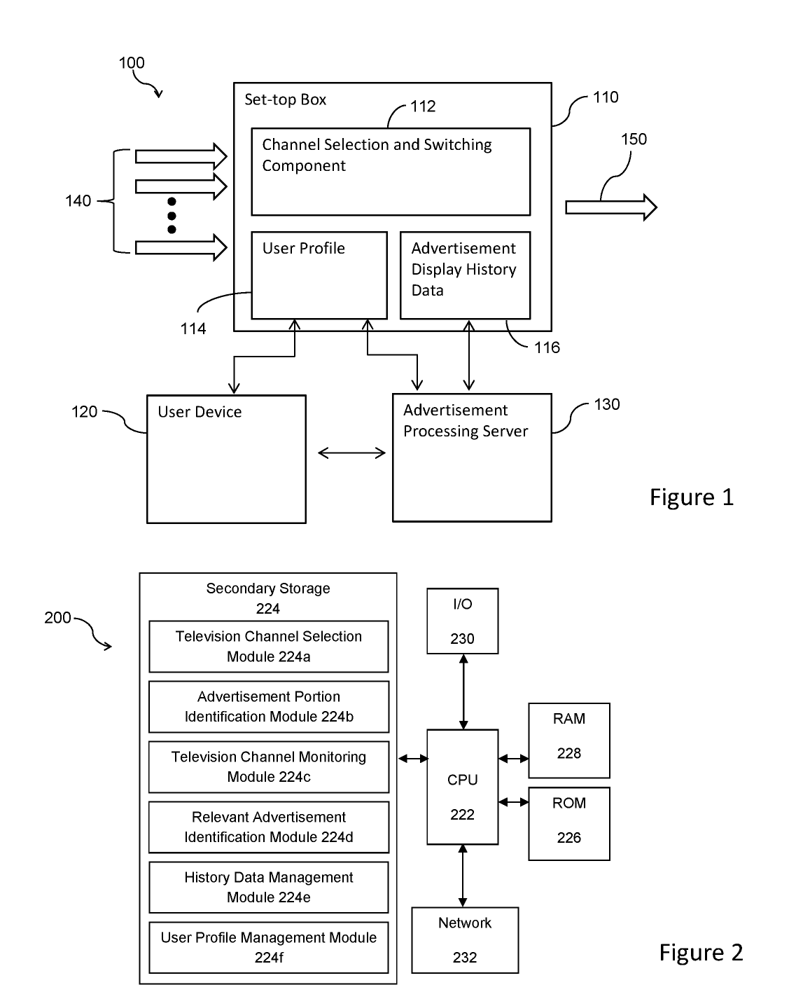

FIG. 1 is a block diagram showing a system for providing television content to a user according to an embodiment of the present invention. The system 100 comprises set-top box 110. The set-top box comprises a channel switching and selection component 112, a user profile storage component 114 and an advertisement display history data storage component 116.

The user profile storage component 114 stores user profile data of a registered user of the set-top box. The user profile data is based on browsing history of the user. The user profile data comprises indications of advertisement categories which as indicated by the user browsing history are relevant to the user. Examples of such categories include: Autos/Cars; Sports; Travel; Fashion; Beauty; and Food & Drink.

The user profile data may be generated based on the browsing history of the user's activity on a user device 120. The user device 120 is a computing device such as a laptop computer, smart phone, or tablet device. In some embodiments, the user will have an account on the service provider website provided by an advertisement processing server 130 and that website will track the browsing history corresponding to that user identity and will transmit it to the set top box 110 The service provider website can use the application program interfaces (APIs) to track the browsing history of the user. In other embodiments, the set-top box 110 may be provided with a wireless network connection such as a Wi-Fi interface which may receive browsing history information directly from the user device 120. The browsing history of the user may be collected from several devices, for example if the user has a common account such as a Google account. In such an implementation, the browsing history of the user on the laptop is reflected in the browsing history of the mobile using a common account on both the devices.

The advertisement processing server 130 is also coupled to the set-top box 110 in order to receive advertisement history data from the advertisement display history data storage component 116.

In use, the set-top box 110 receives a plurality of television channel signals 140. The television channel signals may be received over a cable or fiber-optic connection. In some embodiments, the television channel signals 140 are received as radio-frequency signals on a co-axial cable, with different frequency channels corresponding to different channels of the plurality of television channel signals. The television channel signals 140 each comprise content comprising program content and advertising content. The structure of the television channel signals is described in more detail below with reference to FIG. 3.

The set-top box 110 outputs a television display signal 150 which is coupled to a television device such as a liquid crystal display, plasma display or cathode ray tube display which may also comprise a speaker or a plurality of speakers. The display signal 150 is based upon one of the television channel signals 140.

While in the system shown in FIG. 1 the set-top box 110 is shown as a separate device from the television device, embodiments are envisaged in which the functions of the set-top box 110 are integrated into a television device.

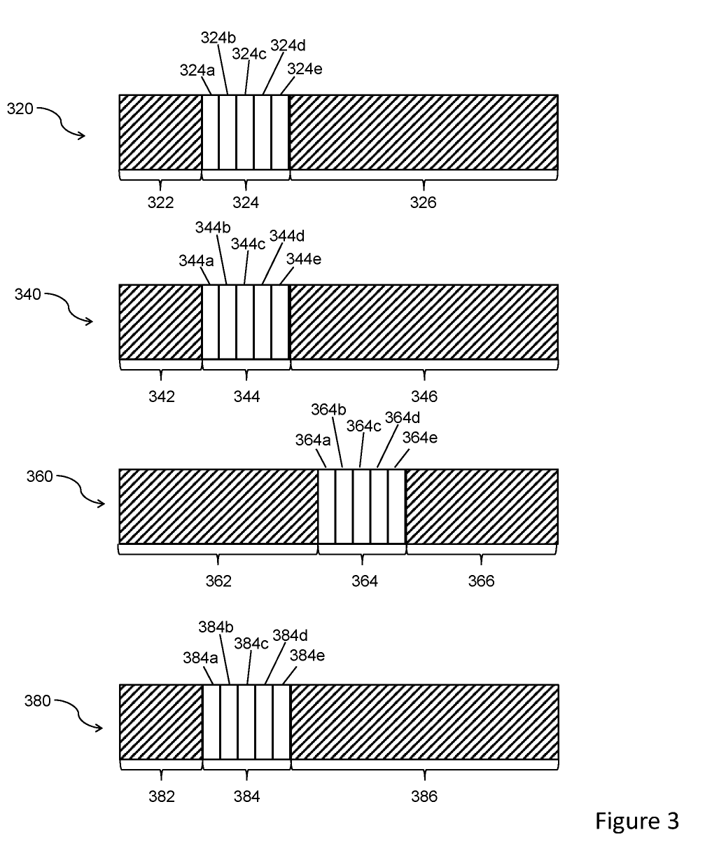

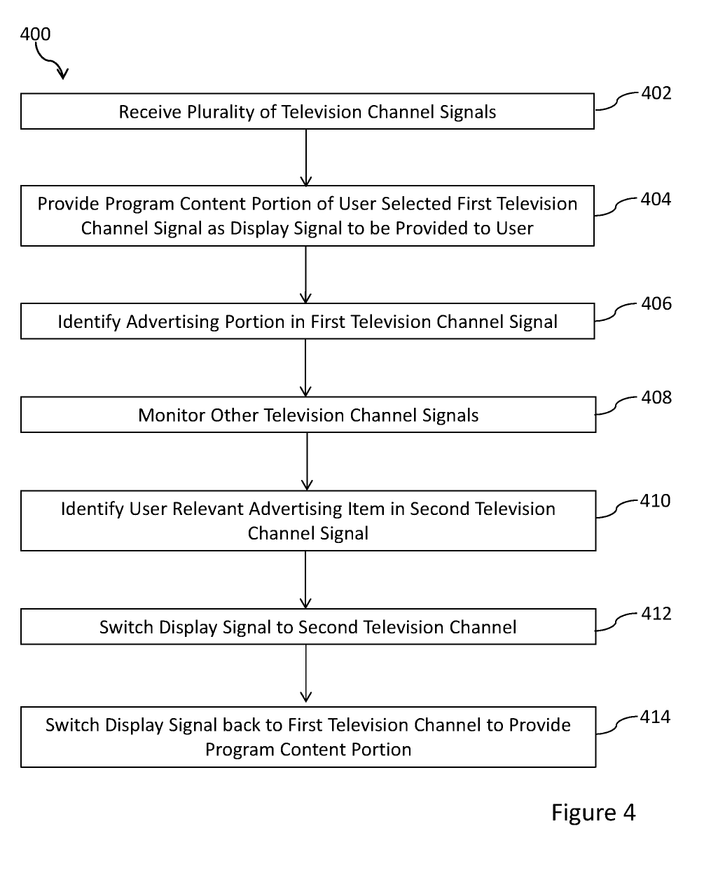

FIG. 2 is a block diagram showing a technical architecture 200 of the channel selection and switching component 112 of the set-top box 110 for performing steps of exemplary methods 400, 500 and 600 which are described below with reference to FIGS. 4, 5 and 6. Typically, the methods methods 400, 500 and 600 are implemented by device or a number of devices having a data-processing unit. The block diagram as shown in FIG. 2 illustrates a technical architecture 200 of a computer device which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a television channel selection module 224a, an advertisement portion identification module 224b, a television channel monitoring module 224c, a relevant advertisement identification module 224d, a history data management module 224e and a user profile management module 224f comprising non-transitory instructions operative by the processor 222 to perform various operations of the method of the present disclosure. As depicted in FIG. 2, the modules 224a-224f are distinct modules which perform respective functions implemented by the set-top box 110. It will be appreciated that the boundaries between these modules are exemplary only, and that alternative embodiments may merge modules or impose an alternative decomposition of functionality of modules. For example, the modules discussed herein may be decomposed into sub-modules to be executed as multiple computer processes, and, optionally, on multiple computers. Moreover, alternative embodiments may combine multiple instances of a particular module or sub-module. It will also be appreciated that, while a software implementation of the modules 224a-224f is described herein, these may alternatively be implemented as one or more hardware modules (such as field-programmable gate array(s) or application-specific integrated circuit(s)) comprising circuitry which implements equivalent functionality to that implemented in software. The ROM 226 is used to store instructions and perhaps data which are read during program execution. The secondary storage 224, the RAM 228, and/or the ROM 226 may be referred to in some contexts as computer readable storage media and/or non-transitory computer readable media.

The I/O devices may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the method operations described herein. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Although the technical architecture 200 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 200 to provide the functionality of a number of servers that is not directly bound to the number of computers in the technical architecture 200. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

FIG. 3 shows the structure of television channel signals which are processed in embodiments of the present invention. FIG. 3 shows four television channel signals: a first television channel signal 320, a second television channel signal 340, a third television channel signal 360, and a fourth television channel signal 380.

As shown in FIG. 3, the first television channel signal 320 comprises a program content portion 322, which is followed by an advertising content portion 324, which in turn is followed by a program content portion 326. The program content portions 322 and 326 may correspond to the same television program, for example a drama, and the advertising content portion 324 corresponds to an advertisement break in the television program. As an example, the first television channel signal may comprise a plurality of program content portions each approximately 15 minutes in length and the advertising content portions may be approximately 5 minutes in length. As shown in FIG. 3, the advertising content portion 324 comprises five advertising content items 324a to 324e which are advertisements for products or services. Each of the advertising content items 324a to 324e has a category associated with it. As mentioned above, the categories may be as follows: Autos/Cars; Sports; Travel; Fashion; Beauty; and Food & Drink. The First television channel signal 320 may also comprise an indication of type of content portion, for example either program content or advertising content. Additionally, when the content is advertising content the first channel signal 320 may comprise an indication of the category of the advertising content item. These indications may also include an identifier of the advertising content item.

The second television channel signal 340 comprises a program content portion 342, which is followed by an advertising content portion 344, which in turn is followed by a program content portion 346. Here, the program content portions 342 and 346 correspond to a different type of program, for example a news or current affairs program. As described above, the advertising content portion 344 corresponds to an advertisement break in the television program. The advertising content portion 344 comprises five advertising content items 344a to 344e which are advertisements for products or services.

The third television channel signal 360 comprises a program content portion 362, which is followed by an advertising content portion 364, which in turn is followed by a program content portion 366. The advertising content portion 364 of the third television channel portion does not overlap with the advertising portion 324 of the first television channel signal 320 and the advertising portion 344 of the second television channel signal 340. The program content portions 362 and 366 of the third television channel signal 360 may for example be live coverage of a sporting event and there the timing of the advertising content portion may be fixed by the timing of the event. The advertising content portion 364 comprises five advertising content items 364a to 364e which are advertisements for products or services.

The fourth television channel signal 380 comprises a program content portion 382, which is followed by an advertising content portion 384, which in turn is followed by a program content portion 386. As shown in FIG. 3, the timing of the advertising portion 384 of the fourth television channel signal 380 overlaps with the advertising portion 324 of the first television channel signal 320 and the advertising portion 344 of the second television channel signal 340. The program content portions 382 and 386 of the fourth television channel signal 380 may for example be a movie. The advertising content portion 384 comprises five advertising content items 384a to 384e which are advertisements for products or services.

Various operations of an exemplary method 400 will now be described with reference to FIG. 4 in respect of generating an electronic signature. It should be noted that enumeration of operations is for purposes of clarity and that the operations need not be performed in the order implied by the enumeration.

FIG. 4 is a flowchart showing a method of providing television content for display to a user according to an embodiment of the present invention.

In step 402, the channel selection and switching component 112 of the set-top box 110 receives a plurality of television channel signals. The plurality of television channel signals may be as depicted in FIG. 3.

In step 404, the television channel selection module 224a of the channel selection and switching component 112 provides program content of a user selected channel, in this case, the first television channel signal 320 as the display signal 150 to be provided to the user. The first channel may correspond to a channel selected by the user, for example by using a remote control of the set-top box to select the channel. Thus, in step 404, the television channel selection module 224a of the channel selection and switching component 112 provides the program content portion 332 of the first channel signal 320 as the display signal 150.

In step 406, the advertisement portion identification module 224b of the channel selection and switching component 112 identifies an advertising portion 324 in the first television channel signal 320. As described above, first television channel signal 320 may comprise an indication of the type of content, for example, advertising content or program content which makes up the channel signal at any given time. The advertisement portion identification module 224b of the channel selection and switching component 112 monitors this indication to identify the advertising portion 324 in the first television channel signal 320.

In step 408, in response to the identification of the advertising portion 324 in the first television channel signal 320, the television channel monitoring portion 224c of the channel selection and switching component 112 monitors other channel signals of the plurality of television channel signals. In the example shown in FIG. 3, the television channel monitoring portion 224c of the channel selection and switching component 112 monitors the second television channel signal 340, the third television channel signal 360 and fourth television channel signal 380. The monitoring of the other television channel signals by the television channel monitoring portion 224c of the channel selection and switching component 112 comprises determining if each of the other channel signals are made up by advertising content portion and if they are, determining the category of the advertising content items making up the respective television channel signals.

In the example shown in FIG. 3, at the time that the first television channel signal 320 enters the advertising portion 324 and begins with the first advertising content item 324a, the television channel monitoring portion 224c of the channel selection and switching component 112 identifies that the second television channel signal 340 also has an advertising portion 344 and identifies a category associated with the first advertising content item 344a of the second television channel signal 340. The television channel monitoring portion 224c of the channel selection and switching component 112 identifies that the third television channel signal 360 does not have an advertising portion at this time. Further, the television channel monitoring portion 224c of the channel selection and switching component 112 identifies that the fourth television channel signal 380 also has an advertising portion 384 and identifies a category associated with the first advertising content item 384a of the fourth television channel signal 380. The television channel monitoring portion 224c of the channel selection and switching component 112 may also identify the category associated with the first advertising content item 324a of the second television channel signal 320.

In step 410, the relevant advertisement identification module 224d of the channel selection and switching component 112 identifies a user relevant advertising item in a second television channel signal. In step 410, the relevant advertisement identification module 224d of the channel selection and switching component 112 compares the category associated with the first advertising content item 344a of the second television channel signal 340 and the category associated with the first advertising content item 384a of the fourth television channel signal 380 with a list of advertisement categories which are indicated by the user profile 114 to be relevant to the user. If an advertising content item has a category that matches a category indicated by the user profile 114 to be relevant to the user, then that advertising content item is identified in step 410 as being relevant to the user.

For example, the if the user profile 114 indicates that the categories of Autos/Cars and Travel are relevant to the user and the category of the first advertising content item 344a of the second television channel signal 340 is Autos/Cars, indicating that there is a car advertisement and the category associated with the first advertising content item 384a of the fourth television channel signal 380 is Beauty indicating that there is an advertisement for a beauty product, then the second first advertising content item 344a of the second television channel signal 340 is identified as a user relevant advertising item.

In step 412, the television channel selection module 224a of the channel selection and switching component 112 switches the display signal 150 from the first television channel signal 320 to the second television channel signal 340, so that the first advertising item 344a of the second television channel signal 340 is displayed to the user. Following step 412, at the end of the first advertising item 344a of the second television channel signal 340, the process of steps 408, 410 and 412 continues so the display signal 150 switched to television channel signals having advertising items which have categories that are relevant to the user. If no advertising items that are relevant to the user are identified, then the display signal may be switched back to the first television channel signal 320.

In step 414, the television channel selection module 224a of the channel selection and switching component 112 switches the display signal 150 back to the first television channel signal 320 to provide the program content portion 326 following the advertisement portion 324. In order to determine when to switch back to the first television channel signal 320, in some embodiments, the television channel monitoring module of the channel selection and switching component 112 may monitor the first television channel signal 320, or alternatively, the switching of channels may take place after a fixed time period has passed. The fixed time period may be determined from the length of the advertising portion 324.

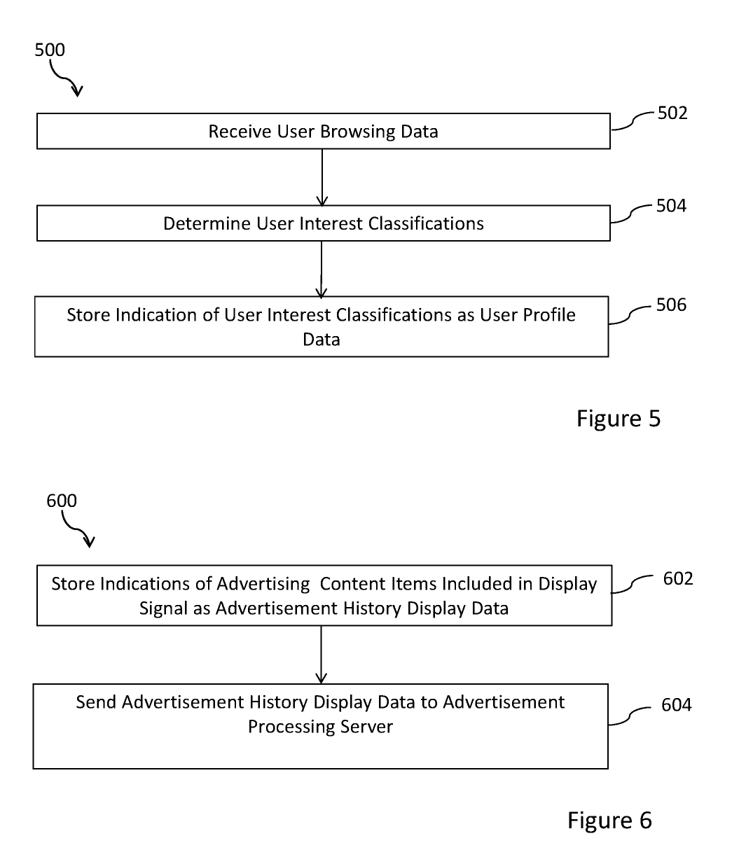

Various operations of an exemplary method 500 will now be described with reference to FIG. 5 in respect of steps of a method of generating and/or updating user browsing data. It should be noted that enumeration of operations is for purposes of clarity and that the operations need not be performed in the order implied by the enumeration.

FIG. 5 is a flowchart showing a method of updating user profile data in an embodiment of the present invention. The method 500 shown in FIG. 5 may be carried out by the set-top box 110 or by a combination of the set-top box 110 and the advertisement processing server 130.

In step 502, user browsing data is received from the user device 120. The user browser data may be received directly from the user device 120 at the set-top box 110, for example via a wireless network interface. Alternatively, the user browsing data may be sent from the user device 120 to the advertisement processing server 130. The user browsing data comprises indications of web pages visited by the user.

In step 504, user interest classifications are determined from the user browsing data. Step 504 may be carried out by the advertisement processing server 130, in which case, the user interest classifications are then sent to the set-top box 110, for example via an internet connection. Alternatively, step 504 may be carried out by the set-top box 110 in the user profile management module 224f of the channel selection and switching component 112.

In step 506, the user profile management module 224f of the channel selection and switching component 112 stores indications of the user interest classifications in the user profile storage component 114 as user profile data.

Various operations of an exemplary method 600 will now be described with reference to FIG. 6 in respect of steps of a method of generating and/or updating user browsing data. It should be noted that enumeration of operations is for purposes of clarity and that the operations need not be performed in the order implied by the enumeration.

FIG. 6 is a flowchart showing a method of storing advertisement history data in an embodiment of the present invention.

In step 602, the history data management module 224e of the channel selection and switching component 112 of the set-top box 110 stores indications of advertising content items included in the display signal 150 as advertisement history display data 116. The data stored may comprise an indication of the advertising content items displayed, and the television channel signal from which they were displayed.

In step 604, the history data management module 224e of the channel selection and switching component 112 of the set-top box 110 sends the advertisement history display data to the advertisement processing server 130. Step 604 may take place over a network or internet connection at regular intervals, for example, weekly or monthly.

The advertisement history display data received by the advertisement processing server 130 may be used in a revenue split model among the operators of the television channels and the brands relating to the advertisements. For example, 80% of the revenue would go the channel on which actually the advertisement was shown, while 20% revenue would go to the channel that was supposed to originally show the advertisement.

Whilst the foregoing description has described exemplary embodiments, it will be understood by those skilled in the art that many variations of the embodiment can be made within the scope and spirit of the present invention.

1. An apparatus for providing television content to a user, the apparatus comprising:
a computer processor and a data storage device, the data storage device having a television channel selection module; an advertisement portion identification module; a television channel monitoring module; and a relevant advertisement identification module comprising non-transitory instructions operative by the processor to:
receive a plurality of television channel signals, each television channel signal comprising program content portions and advertising content portions, the advertising portions each comprising at least one advertising content item;
provide a program content portion of a user selected first television channel signal from the plurality of television channel signals as a display signal to be displayed to the user;
identify an advertising content portion in the first television channel signal;
monitor a plurality of other television channel signals of the plurality of television channel signals during the advertising portion of the first television channel signal;
identify a user relevant advertising content item in a second television channel signal of the plurality of other television channel signals during the advertising portion of the first television channel signal; and
switch the display signal to the second television channel signal.

2. An apparatus according to claim 1, the relevant advertisement identification module further comprising non-transitory instructions operative by the processor to: identify a user relevant advertising content item by comparing a content category indication associated with advertising content items in each of the plurality of television channel signals with stored user profile data indicating content categories relevant to the user.

3. An apparatus according to claim 2, data storage device further comprising a user profile management module comprising non-transitory instructions operative by the processor to: receive user browsing data indicating browsing history of the user; determine content categories relevant to the user from the user browsing data; and store indications of the content categories relevant to the user as user profile data.

4. An apparatus according to claim 1, wherein the television channel selection module further comprises non-transitory instructions operative by the processor to switch the display channel back to the first television channel signal after an advertising portion duration time has passed.

5. An apparatus according to claim 1, wherein the television channel selection module further comprises non-transitory instructions operative by the processor to switch the display channel back to the first television channel signal when a program content portion is identified on the first television channel signal.

6. An apparatus according to claim 1, data storage device further comprising a history data management module comprising non-transitory instructions operative by the processor to: store indications of advertising content items included in the display signal as advertisement history display data.

7. An apparatus according to claim 6, wherein the history data management module further comprises non-transitory instructions operative by the processor to: send the advertisement history display data to an advertising processing server.

8. An apparatus according to claim 1, wherein the advertisement portion identification module further comprises non-transitory instructions operative by the processor to: identify an advertising portion in the first television channel signal from a content type indicator in the first television channel signal.

9. A set-top box comprising an apparatus according to claim 1.

10. A method of providing television content to a user, the method comprising
receiving a plurality of television channel signals, each television channel signal comprising program content portions and advertising content portions, the advertising portions each comprising at least one advertising content item;
providing a program content portion of a user selected first television channel signal from the plurality of television channel signals as a display signal to be displayed to the user;
identifying an advertising content portion in the first television channel signal;
monitoring a plurality of other television channel signals of the plurality of television channel signals during the advertising portion of the first television channel signal;
identifying a user relevant advertising content item in a second television channel signal of the plurality of other television channel signals during the advertising portion of the first television channel signal; and
switching the display signal to the second television channel signal.

11. A method according to claim 10, wherein identifying a user relevant advertising content item in a second television channel signal of the plurality of other television channel signals during the advertising portion of the first television channel comprises comparing a content category indication associated with advertising content items in each of the plurality of television channel signals with stored user profile data indicating content categories relevant to the user.

12. A method according to claim 11, further comprising: receiving user browsing data indicating browsing history of the user; determining content categories relevant to the user from the user browsing data; and storing indications of the content categories relevant to the user as user profile data.

13. A method according to claim 10, further comprising switching the display channel back to the first television channel signal after an advertising portion duration time has passed.

14. A method according to claim 10, further comprising switching the display channel back to the first television channel signal when a program content portion is identified on the first television channel signal.

15. A method according to claim 10, further comprising: storing indications of advertising content items included in the display signal as advertisement history display data.

16. A method according to claim 15, further comprising sending the advertisement history display data to an advertising processing server.

17. A method according to claim 10, further comprising identifying an advertising portion in the first television channel signal from a content type indicator in the first television channel signal.

18. A computer readable medium carrying computer executable instructions which when executed on a processor cause the processor to carry out a method according to claim 10.
